(19) United States
(12) Patent Application Publication
(10) Pub. No.: US 2009/0323336 A1
(43) Pub. Date: Dec. 31, 2009

(54) LED LAMP

(75) Inventors: Jer-Haur Kuo, Taipei Hsien (TW); Shun-Yuan Jan, Taipei Hsien (TW); Fang-Xiang Yu, Shenzhen City (CN); Xin-Xiang Zha, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Taipei Hsien (TW)

(21) Appl. No.: 12/248,009

(22) Filed: Oct. 8, 2008

(30) Foreign Application Priority Data
Jun. 27, 2008 (CN) 200810068057.X

(51) Int. Cl. F21V 7/07; F21V 7/00

(52) U.S. Cl. 362/247; 362/296.07

(57) ABSTRACT

An LED lamp (100) includes a lamp enclosure (10), two arrays of LEDs (33) and a fixing plate (20). The lamp enclosure defines a depression (15) therein and an opening (156) at a top side thereof. The LEDs are received in the depression. The fixing plate is vertically received in the depression and has two lateral sides (23) facing towards an internal surface (110) of the lamp enclosure. The LEDs are mounted on two LED modules (30) which are respectively mounted on the lateral sides of the fixing plate so that the light rays (71, 73) emitted by the LEDs are firstly directed to and reflected by the internal surface of the lamp enclosure, and then directed to an outside of the LED lamp through the opening.

### BACKGROUND

1. Field of the Invention

The present invention relates to a light emitting diode (LED) lamp, and more particularly to an LED lamp which can provide soft and uniform light.

2. Description of Related Art

As an energy-efficient light, an LED lamp has a trend of substituting for the fluorescent lamp for a lighting purpose. In order to increase the overall lighting brightness, a plurality of LEDs are often incorporated into a lamp. It is well known that the LEDs are arranged in the form of point light sources in the lamp. Thus, uncomfortable glare may be caused by the LED light sources.

What is needed, therefore, is an LED lamp which can provide soft and even light.

### SUMMARY

An LED lamp in accordance with an embodiment of the present invention includes a lamp enclosure, two LED modules and a fixing plate. The lamp enclosure defines a depression therein and an opening at a top side thereof. The LED modules are received in the depression. The fixing plate is vertically received in the depression and has two lateral sides facing towards an internal surface of the lamp enclosure. The LED modules are respectively mounted on the lateral sides of the fixing plate so that the light rays emitted by the LED modules are firstly directed to and reflected by the internal surface of the lamp enclosure, and then directed to the outside through the opening.

Other advantages and novel features of the present invention will become more apparent from the following detailed description when taken in conjunction with the accompanying drawings.

### BRIEF DESCRIPTION OF THE DRAWINGS

Many aspects of the present LED lamp can be better understood with reference to the following drawings. The components in the drawings are not necessarily drawn to scale, the emphasis instead being placed upon clearly illustrating the principles of the present LED lamp. Moreover, in the drawings, like reference numerals designate corresponding parts throughout the several views.

FIG. 1 is an assembled, isometric view of an LED lamp in accordance with a first embodiment of the present invention.

FIG. 2 is an exploded, isometric view of the LED lamp shown in FIG. 1.

FIG. 3 is a top plan view of the LED lamp shown in FIG. 1.

FIG. 4 is a cross-sectional view of the LED lamp shown in FIG. 1, along the line IV-IV.

FIG. 5 is a cross-sectional view of an LED lamp in accordance with a second embodiment of the present invention.

### DETAILED DESCRIPTION

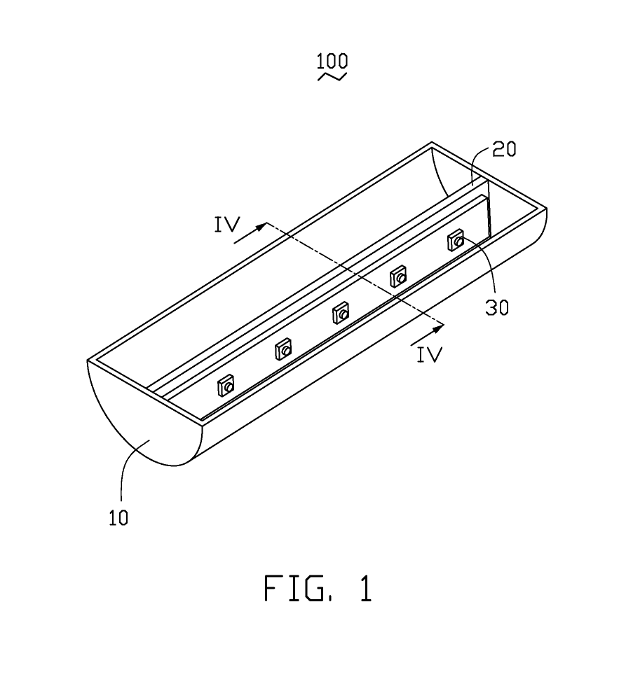

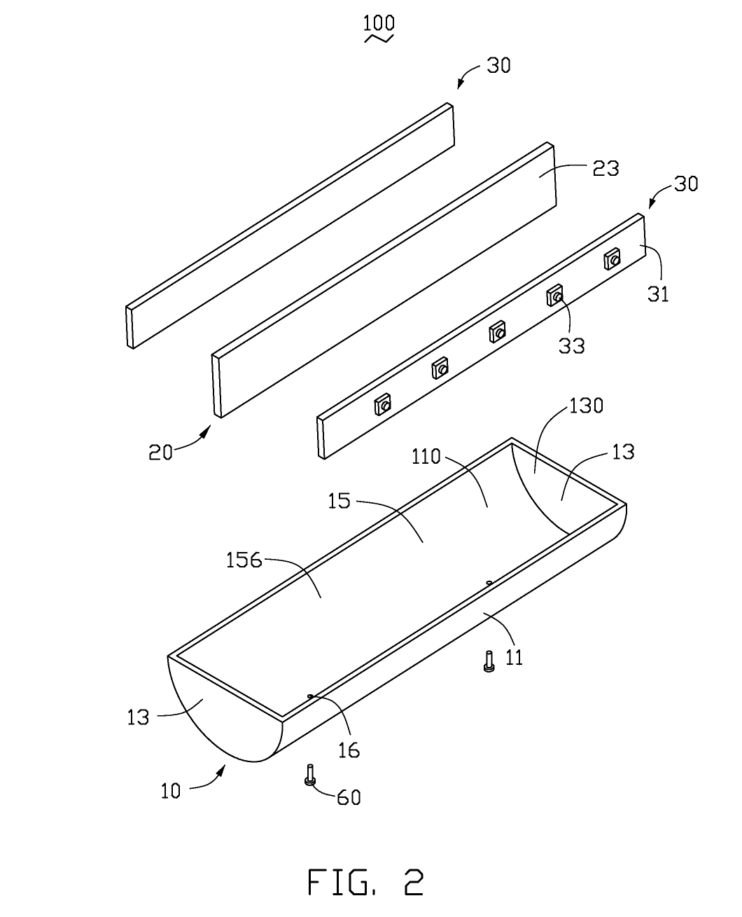

Referring to FIGS. 1 and 2, an LED lamp 100 in accordance with a first embodiment of the present invention is shown. The LED lamp 100 comprises a lamp enclosure 10, a fixing plate 20 and two LED modules 30, wherein only one LED module 30 is visible in FIG. 1. The lamp enclosure 10 has a concave configuration. The fixing plate 20 and the LED modules 30 are mounted inside the lamp enclosure 10.

The lamp enclosure 10 includes a concave housing 11 and two side plates 13 integrally connected to two opposite ends of the housing 11, respectively. The housing 11 has an elongated configuration. The housing 11 has a U-shaped cross section so that the housing 11 has a U-shaped internal surface 110. Two through holes 16 are defined in a bottom of the housing 11. Alternatively, the lamp enclosure 10 can be formed to have a different shape selected from a group consisting of hemispheroid, semi ellipsoid and arched shape.

The side plates 13 are semi-circular, flat plates and are respectively located at two longitudinal ends of the housing 11. The side plates 13 and the housing 11 cooperatively form a depression 15. The side plates 13 each have an internal surface 130 facing towards the depression 15.

The lamp enclosure 10 defines an opening 156 at a top side thereof. The opening 156 communicates the depression 15 with ambient air over the lamp enclosure 10. The depression 15 has a width which increases gradually from a bottom-to-top direction of the housing 11. A high reflective material can be painted on the internal surfaces 110, 130.

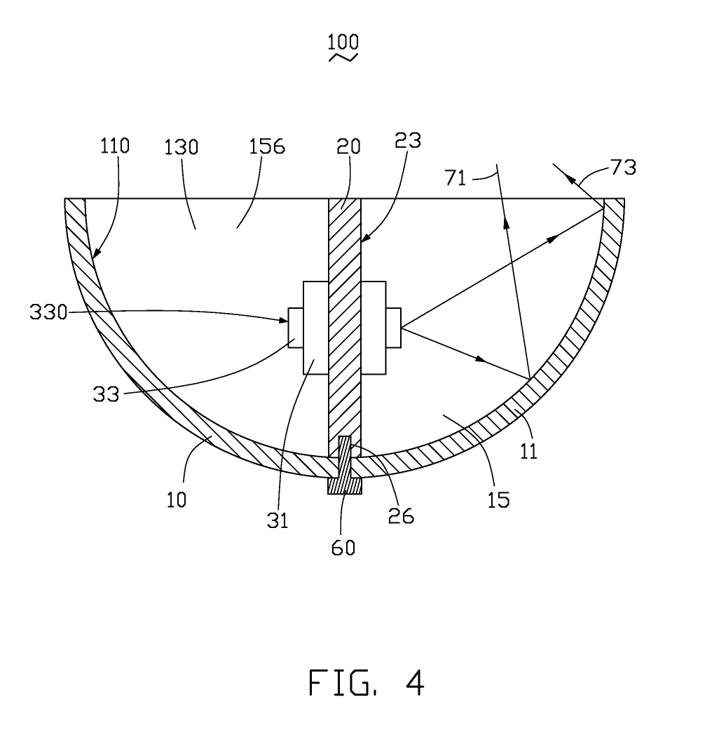

The fixing plate 20 is made of a material having good heat conduction, such as aluminum or copper. The fixing plate 20 is a rectangular, elongated, flat plate and has a same longitudinal length as that of the housing 11. The fixing plate 20 is received in a middle of the depression 15 and two opposite longitudinal ends of the fixing plate 20 respectively abut against the internal surfaces 130 of the side plates 13. The fixing plate 20 has two opposite lateral side surfaces 23 for respectively mounting the LED modules 30 thereon. Two fixing holes 26 (shown in FIG. 4) are defined in a bottom of the fixing plate 20 at positions respectively corresponding to the through holes 16 of the housing 11. Two screws 60 respectively extend through the through holes 16 to engage in the corresponding fixing holes 26, so that the fixing plate 20 is vertically connected with the housing 11 with the lateral side surfaces 23 facing towards the internal surface 110 of the housing 11. Alternatively, the fixing plate 20 can be integrally formed with the housing 11.

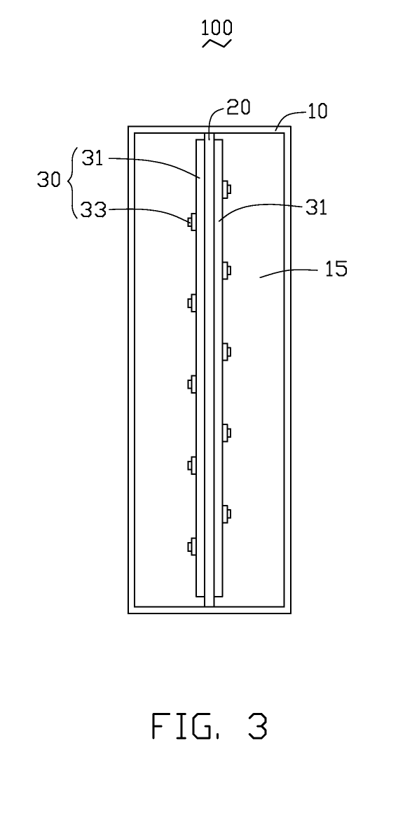

Referring to FIG. 3, the LED modules 30 each include an elongated flat substrate 31 and a plurality of LEDs 33 spaced from each other and equidistantly mounted on the substrate 31. Generally, the substrate 31 is a printed circuit board. The substrate 31 has an elongated configuration slightly shorter than the fixing plate 20. The substrates 31 extend along a direction parallel to the fixing plate 20. The substrates 31 are respectively vertically mounted on the lateral side surfaces 23 of the fixing plate 20 by soldering, or other conventional methods. Accordingly, the LEDs 33 of the LED modules 30 are arranged in two arrays, i.e., the first array disposed at the left side of the fixing plate 20 and the second array disposed at the right side of the fixing plate 20, as viewed in FIG. 3. Along a longitudinal direction of the fixing plate 20, the LEDs 33 of the two arrays are alternately arranged to each other so that no LEDs 33 of the two arrays are aligned with each other along a traverse direction of the LED lamp 100 as viewed from FIG. 3. Thus, heat generated by the LEDs 33 can be dispersed uniformly on the substrates 31 and the fixing plate 20, and the LEDs 33 will not become overheated during operation.

Referring to FIG. 4, the fixing plate 20 is located in a middle of the depression 15 so as to divide the depression 15 into two symmetrical apartments beside the fixing plate 20 and along a transverse direction of the housing 11. Each of the LEDs 33 has a light emitting surface 330. The light emitting surface 330 is oriented towards the internal surface 110 of the housing 11 so that light rays emitted by the light emitting surface 330 are directed to the internal surface 110 of the lamp enclosure 10. For example, a portion of light rays 71 emitted by the light emitting surface 330 is firstly directed to and reflected by the internal surface 110, and then directed to the opening 156. There is still another portion of light rays directed to and reflected by the internal surface 130 of a corresponding side plate 13, and then directed to the opening 156. Especially in the first embodiment, an outmost portion of light rays 73, which is emitted from an outmost periphery of the light emitting surface 330, is directed to intersect with a top edge of the housing 11.

In a word, the LED lamp 100 is arranged in such a manner that the LEDs 33 do not directly emit their light rays to the opening 156. All of the light rays of the LED lamp 100 are firstly directed to and reflected by the internal surfaces 110, 130 of the housing 11 and then directed to outside environment through the opening 156. Thus, users will not see the light rays of the LEDs 33 directly so that uncomfortable glare is reduced. Accordingly, the LED lamp 100 can provide soft and uniform light for users.

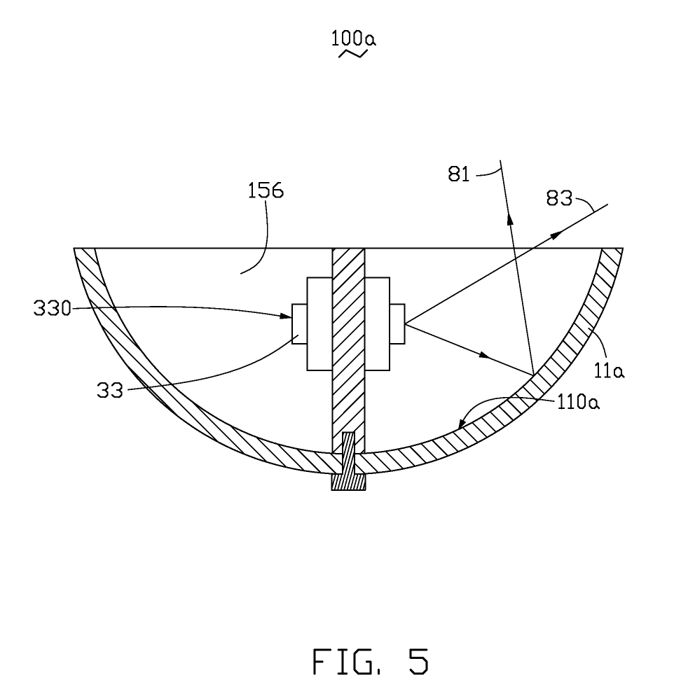

In a second embodiment of the present invention, an LED lamp 100a shown in FIG. 5 is similar to the LED lamp 100. The LED lamp 100a differs from the LED lamp 100 only in the structure of a housing 11a. A vertical height of the housing 11a is shorter than that of the housing 11 so that an outmost portion of light rays 83 emitted by the light emitting surface 330 of the LED 33 is directly emitted to outside environment through the opening 156, while most of light rays 81 of the light emitting surface 330 is firstly directed to and reflected by an internal surface 110a of the housing 11a and then directed to the opening 156.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An LED lamp comprising:
a lamp enclosure having a concave configuration;
a fixing plate; and
at least one LED module, wherein
an opening is defined at a top side of the lamp enclosure, the fixing plate and the at least one LED module are received in the lamp enclosure, the fixing plate is fixed to the lamp enclosure, the at least one LED module is attached to a lateral side of the fixing plate and faces towards an internal surface of the lamp enclosure, and at least a portion of light rays emitted by the at least one LED module is firstly directed to and reflected by the internal surface of the lamp enclosure, and then directed to an outside of the LED lamp through the opening.

2. The LED lamp as claimed in claim 1, wherein the fixing plate is vertically disposed in the lamp enclosure.

3. The LED lamp as claimed in claim 1, wherein the lamp enclosure includes an elongated housing, and the housing has a U-shaped cross section.

4. The LED lamp as claimed in claim 3, wherein the lamp enclosure further comprises two side plates respectively connected to two opposite ends of the housing, the side plates and the housing cooperatively form a depression, and the depression has a width which increases gradually from a bottom-to-top direction of the housing.

5. The LED lamp as claimed in claim 4, wherein the fixing plate is a rectangular elongated plate and is received in a middle of the depression, and the fixing plate has two opposite lateral side surfaces facing towards an internal surface of the housing.

6. The LED lamp as claimed in claim 5, wherein the at least one LED module includes two LED modules, each of the LED modules includes an elongated substrate and a plurality of LEDs spaced from each other and equidistantly mounted on the substrate, and the substrates are respectively attached to the lateral side surfaces of the fixing plate.

7. The LED lamp as claimed in claim 6, wherein the LEDs of the LED modules are arranged in two arrays, and the two arrays of the LEDs are respectively disposed at left and right side surfaces of the fixing plate and face towards the internal surface of the housing.

8. The LED lamp as claimed in claim 7, wherein each of the LEDs has a light emitting surface, the light emitting surface is oriented towards the internal surface of the housing so that light rays emitted by the light emitting surface are directed to the internal surface of the housing.

9. The LED lamp as claimed in claim 7, wherein the LEDs of the LED modules are alternately arranged along a longitudinal direction of the fixing plate so that no LEDs are aligned with each other along a traverse direction of the LED lamp.

10. The LED lamp as claimed in claim 5, wherein the fixing plate has a same longitudinal length as that of the housing and two opposite longitudinal ends of the fixing plate respectively abut against the side plates, and a bottom of the fixing plate is connected to the housing.

11. An LED lamp comprising:
a lamp enclosure comprising a depression; and
a plurality of LEDs received in the depression and arranged in two arrays, wherein
an opening is defined at a top side of the lamp enclosure to communicate the depression with an outside of the lamp enclosure, the two arrays of the LEDs are disposed in the depression with back-to-back arrangement, the light rays emitted by each of the LEDs are firstly directed to and reflected by an internal surface of the lamp enclosure, and then directed to the outside of the lamp enclosure through the opening.

12. The LED lamp as claimed in claim 11, further comprising a fixing plate, wherein the fixing plate is vertically received in the depression and has two opposite lateral side surfaces facing towards the internal surface of the lamp enclosure, and the two arrays of the LEDs are vertically mounted on the lateral side surfaces of the fixing plate, respectively.

13. The LED lamp as claimed in claim 12, wherein the two arrays of the LEDs are alternately arranged along an extension direction of the fixing plate.
